(19) United States
(12) Patent Application Publication
(10) Pub. No.: US 2025/0030964 A1
(43) Pub. Date: Jan. 23, 2025

(54) ANALOG CAMERA ADAPTER

(71) Applicant: Pro-Vision Solutions, LLC, Byron Center, MI (US)

(72) Inventors: Xinuo Zhao, Sanya (CN); Matthew Thomas Lehnert, Byron Center, MI (US)

(73) Assignee: Pro-Vision Solutions, LLC, Byron Center, MI (US)

(21) Appl. No.: 18/775,820

(22) Filed: Jul. 17, 2024

Related U.S. Application Data
(60) Provisional application No. 63/527,708, filed on Jul. 19, 2023.

(51) Int. Cl. H04N 25/78; B60R 1/22

(52) U.S. Cl. CPC H04N 25/78; B60R 1/22; B60R 2300/105; B60R 2300/30

(57) ABSTRACT

A camera system includes a digital recording unit. The camera system further includes a camera adapter having a first cable having a connector that connects to a digital connection port of the digital recording unit, and a second cable that connects to a camera port of an analog camera. The camera adapter may include first and second processors that are configured to convert analog audio and/or video signals from the analog camera into digital audio and/or video signals and transmit the digital signals to the digital recording unit through the first cable. The camera adapter may be configured to supply power from the digital connection port of the digital recording unit to the camera port of the analog camera.

### CROSS-REFERENCE TO RELATED APPLICATION

This application claims the benefit under 35 U.S.C. § 119 (e) to U.S. Provisional Patent Application No. 63/527,708 filed Jul. 19, 2023, entitled “ANALOG CAMERA ADAPTER,” which is incorporated herein by reference in its entirety.

### BACKGROUND OF THE INVENTION

Various types of camera systems for vehicles have been developed. Known systems may include one or more cameras that are operably connected to a recording unit that is onboard the vehicle.

### SUMMARY OF THE INVENTION

One aspect of the present disclosure is a camera system that may be utilized in vehicles. The camera system includes a digital recording unit having a support structure and first and second cameras mounted to the support structure. The support structure of the digital recording unit may be configured to be mounted to a vehicle. The support structure of the digital recording unit may optionally be configured to be mounted in a vehicle interior adjacent to a windshield of a vehicle (or directly to a windshield) whereby the first camera faces forward towards the windshield, and the second camera may face rearwardly away from the windshield. The first and second cameras may optionally be configured to form videos that are stored in digital format by the digital recording unit. The digital recording unit may optionally include a digital connection port that is configured to send and receive digital signals. The digital connection port may optionally be configured to supply electrical power. The electrical power may optionally comprise 12V DC power. The camera system may include a third camera that is configured to output an analog audio and/or video signal. The third camera may optionally be configured such that the analog signal is output from a camera port of the third camera. The camera port of the third camera may optionally be configured to receive 12V DC power to power the third camera. The camera system includes an analog camera adapter having: 1) a housing, 2) a first cable having a first end that is removably or releasably connected to the housing and a second end having a digital connector that is configured to be operably connected to the digital connection port of the digital recording unit, and 3) a second cable having a first end that is removably or releasably connected to the housing, and a second end having an analog connector that is configured to be operably connected to the camera port of the third camera. The analog camera adapter optionally includes first and second processors disposed in the housing. The first and second processors may be operably interconnected, and the second processor may be configured to convert analog video signals from the third camera into digital video signals whereby the digital video signals may be transmitted to the first processor. The first processor may be configured to convert analog audio signals from the third camera into digital audio signals. The first processor may also be configured to transmit the digital audio signals and digital video signals to the digital recording unit through the first cable. The analog camera adapter may also be configured to: 1) supply 12V DC power from the digital connection port of the digital recording unit to the camera port of the third camera utilizing one or more (e.g. first and second) conductive power lines of the first and second cables, and 2) communicate with the digital recording unit utilizing first and second conductive communication lines of the first cable.

Another aspect of the present disclosure is an analog to digital camera adapter for connecting an analog camera to a digital recorder. The analog to digital camera adapter may include a housing and analog to digital convertor electronics disposed in the housing. The analog to digital camera adapter may include a first (digital) line having a digital connector that is adapted to operably couple the digital line to a digital recording unit that is remote from the high definition analog camera. The digital line may be adapted to be operably connected to a digital output of the digital convertor electronics to provide two-way digital communication between the analog to digital convertor electronics and a digital recorder. The analog to digital camera adapter may further include a second (analog) line including a connector that is adapted to operably couple the analog line to a high definition analog camera. The analog line may be operably connected to an analog input of the digital convertor electronics. The analog to digital camera adapter may further include conductive power lines that are configured to supply the connector of the analog line with 12V DC power received from a digital recorder by the digital connector.

Another aspect of the present disclosure is a method of providing a digital recording unit with digital signals from an analog camera. The method includes mounting a digital recording unit in an interior of a motor vehicle. The digital recording unit may optionally include first and second cameras. The method further includes mounting an analog camera to the motor vehicle in a location that is remote from the digital recording unit. The motor vehicle may optionally include a trailer, and the analog camera may optionally be mounted to the trailer of the motor vehicle. The method includes interconnecting the analog camera to the digital recording unit utilizing an analog camera adapter having analog to digital electronics. The analog to digital electronics are optionally disposed in a housing. The analog to digital electronics may be operably connected to first and second cables (lines) extending from the housing. Interconnecting the analog camera to the digital recording unit may further include interconnecting the first cable to a digital connection port of the digital recording unit, and interconnecting the second cable to the analog camera whereby analog signals from the analog camera are converted to digital signals by the analog to digital electronics and transmitted to the digital recording unit by the first cable. The method further includes providing 12V DC power from the digital recording unit to the analog camera utilizing the first and second cables.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially schematic side elevational view of a motor vehicle and

camera system according to an aspect of the present disclosure;

FIG. 2 is a fragmentary, partially schematic, enlarged cross-sectional view of a portion of the roof of the vehicle of FIG. 1;

FIG. 3 is a partially fragmentary schematic showing a camera system according to an aspect of the present disclosure;

FIG. 4 is a partially fragmentary plan view of a portion of a camera adapter according to an aspect of the present disclosure showing analog to digital electronics on a first side of a printed circuit board (PCB);

FIG. 5 is a partially fragmentary plan view of a portion of a camera adapter according to an aspect of the present disclosure showing analog to digital electronics on a second side of a PCB;

FIG. 6 is a partially fragmentary view of an analog camera adapter according to an aspect of the present disclosure;

FIG. 7 is a schematic showing a first processor that may be utilized in the system of FIGS. 1-6;

FIG. 8 is a schematic showing a second processor that may be utilized in the system of FIGS. 1-6;

FIG. 9 is a schematic of a power regulator that may be utilized in the system of FIGS. 1-6;

FIG. 10 is a schematic of a power regulator that may be utilized in the system of FIGS. 1-6;

FIG. 11 is a schematic of a power regulator that may be utilized in the system of FIGS. 1-6; and

FIG. 12 is a schematic of a power regulator that may be utilized in the system of FIGS. 1-6.

### DETAILED DESCRIPTION

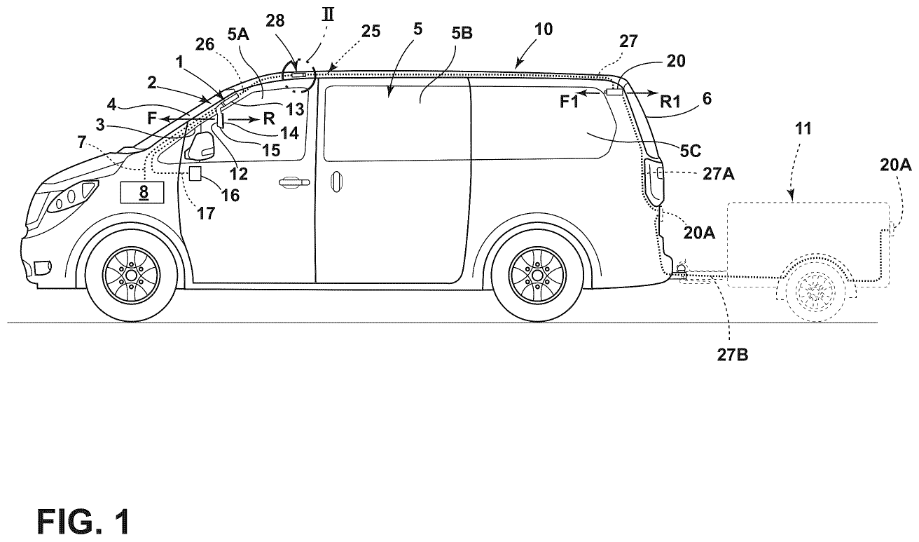

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations and step sequences, except where expressly specified to the contrary. It is also to be understood that the specific devices and processes illustrated in the attached drawings, and described in the following specification are simply exemplary embodiments of the disclosure and inventive concepts defined in the appended claims. Hence, specific dimensions and other physical characteristics relating to the embodiments disclosed herein are not to be considered as limiting, unless the claims expressly state otherwise.

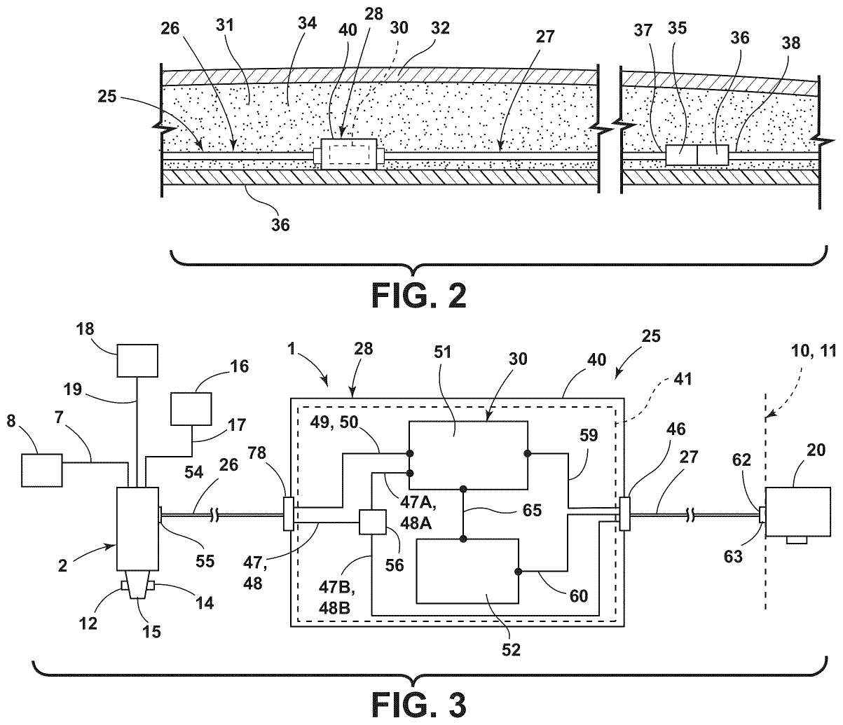

With reference to FIG. 1, a camera system 1 may include a drive recorder unit 2 that is mounted to a vehicle 10. As discussed in more detail below, drive recorder unit 2 may be operably connected to an analog camera 20 by a camera adapter 25 having a converter 28 that converts analog signals from analog camera 20 into a digital format and provides the digital signals to drive recorder unit 2. Converter 28 includes Analog to Digital (A/D) converter electronics 30 that are disposed inside a housing 40 (FIGS. 2 and 3). Drive recorder unit 2 may optionally be configured to be mounted to an interior surface 3 of a windshield 4 of vehicle 10. In the illustrated example, vehicle 10 comprises a van having an interior 5 with a front interior area 5A, a central interior area 5B, and a rear interior area 5C. However, it will be understood that the camera system 1 of the present disclosure is not limited to any particular vehicle type. For example, vehicle 10 may comprise a tractor-trailer that includes a trailer 11.

Drive recorder unit 2 may be configured to store digital audio and/or digital images (e.g. videos). The recorder unit 2 may comprise, for example, a DR-200 HD fleet-cam and drive recorder available from PRO-VISION, INC.®, of Byron Center, Michigan. However, it will be understood that the present disclosure is not limited to a specific drive recorder unit. In the illustrated example, recorder unit 2 includes a first camera 12 that faces in a forward direction “F” through vehicle windshield 4. Recorder unit 2 also includes a second camera 14 facing in a rear direction “R.” The cameras 12 and 14 may be mounted to a lower structure/portion 15 of recorder unit 2. Lower structure/portion 15 may (optionally) be movable (e.g. pivotable about a horizontal axis) relative to an upper structure/portion 13 of recorder unit 2 whereby the camera directions F and R can be adjusted. The recorder unit 2 may optionally be secured to the inner surface 3 of windshield 4 utilizing adhesives or other suitable materials. A power line or lines 7 may be utilized to operably connect recorder unit 2 to a vehicle power supply 8 (see also FIG. 3). Vehicle power supply 8 may comprise a conventional 12V DC electrical power system. Recorder unit 2 may also, optionally, be operably connected to an input 16 by a first line 17. Input 16 may comprise an event button that may be pressed (manually actuated) by a user to initiate recording by cameras 12 and/or 14 and/or 20. It will be understood that various inputs may be utilized to initiate recording by one or more of the cameras 12 and/or 14 and/or 20. Drive recorder unit 2 may also include additional inputs to operably connect the drive recorder unit 2 to one or more triggers (not shown) that may also activate one or more cameras 12 and/or 14 and/or 20.

Camera system 1 may include a third camera 20 that is operably connected to the drive recorder unit 2 by adapter 25 (see also FIGS. 2 and 3). Adapter 25 includes first and second cables or lines 26 and 27 that operably interconnect A/D converter electronics 30 of converter 28 to drive recorder unit 2 and camera 20, respectively. Camera 20 may comprise a high definition (HD) analog camera that is operably connected to a second (analog) cable or line 27 of adapter 25. The line 27 is operably connected to A/D converter electronics 30 which converts high definition analog audio and/or video signals from camera 20 into digital signals, and transmits the digital signals to recorder unit 2 utilizing first (digital) line 26. It will be understood that lines 26 and 27 may have virtually any suitable configuration, and, as used herein, the terms “analog” and “digital” are not limited to a specific configuration.

In an illustrated example (FIG. 1), the analog camera 20 is mounted in the rear internal space 5C whereby the analog camera 20 faces in a forward direction “F1” to record video of intermediate portion 5B and/or rear portion 5C of interior space 5 that may not be fully visible from second camera 14. Camera 20 may also be mounted to face in rearward direction R1 towards a rear window 6 of vehicle 10. It will be understood that the third camera 20 may be mounted in virtually any suitable position. Adapter 25 permits camera 20 to be operably connected to the recorder unit 2 when camera 20 is mounted in virtually any location. For example, the analog camera 20 may be mounted in an exterior, rear-facing position designated 20A in FIG. 1 to enable video recording of the area behind (outside) of vehicle 10 and camera 20 may be operably connected to recorder unit 2 by line 27A. If vehicle 10 comprises a truck (e.g. a semi trailer), the camera 20 may be mounted to a rear side of the trailer 11 at location “20B” (FIG. 1). In general, the lengths of the lines 26 and/or 27 may be sized as required for a particular application. Alternatively, one or more extension lines 38 (FIG. 2) may be utilized to extend the length of line 26 and/or line 27 as required for a particular application.

With reference to FIG. 2, the line 26, line 27, and converter 28 may, optionally, be mounted in a space 31 between an outer roof layer 32 and headliner 33 of vehicle 10. If necessary, insulation 34 may be cut or pushed aside to permit installation of the lines 26 and 27 and housing 40 of converter 28 in the space 31. The end 37 of line 27 may include a connector 35 that is configured to be coupled to a connector 36 of an extension line 38 if necessary to operably connect the analog camera 20 to the recorder unit 2. It will be understood that the adapter 25 may be mounted in virtually any suitable manner, and the present disclosure is not limited to the mounting arrangement illustrated in FIG. 2. For example, adapter 25 or portions thereof may be positioned below headliner 33, or positioned on an exterior of vehicle 10, or on trailer 11.

With reference to FIG. 3, the A/D converter electronics 30 of converter 28 may optionally be mounted to a printed circuit board (PCB) 41 that may optionally be positioned inside housing 40. The A/D converter electronics 30 may include a first processor 51 and a second processor 52. The first processor 51 may comprise, for example, a T31N smart video application processor that is available from LUMISSIL MICROSYSTEMS® of Milpitas, California. The second processor 52 may comprise a Techpoint TP9950 processor available from Techpoint U.S.A, San Jose, California. It will be understood that these are merely examples of suitable processors, and the present disclosure is not limited to these specific examples. For example, the A/D converter electronics 30 may comprise A/D circuitry, a single processer, two processors, or three or more processors. Thus, the present disclosure is not limited to a specific type or number of processors.

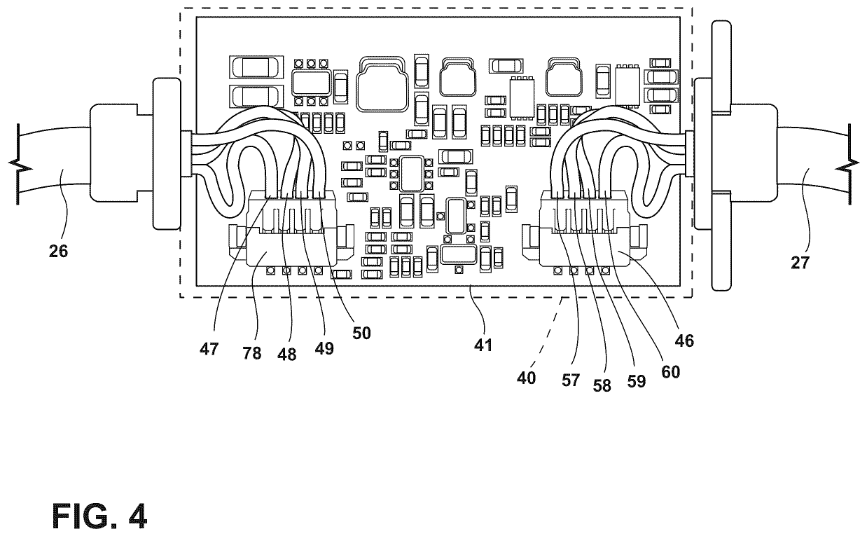

Line or cable 26 may comprise a USB cable having four conductors. The four conductors may comprise first and second power lines 47 and 48 (see also FIG. 4), and first and second data lines 49 and 50 that are operably connected to the PCB 41 at a connector 78. Referring again to FIG. 3, the cable 26 may include a connector 54 that connects to a port 55 of recorder unit 2 to electrically interconnect cable 26 to recorder unit 2. The connectors 54 and port 55 may comprise male and female four pin circular aviation style connectors that provide secure physical and electrical connections.

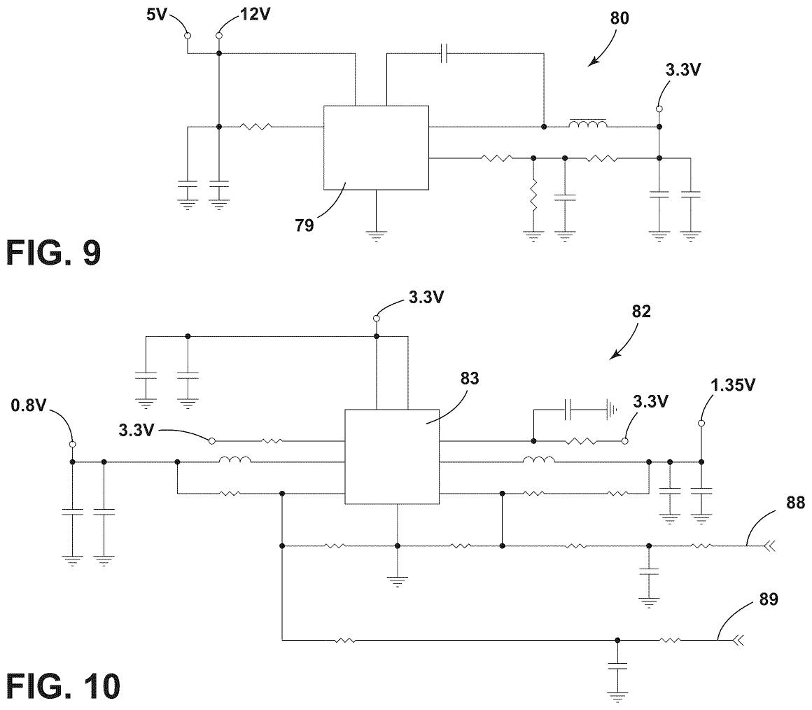

The recorder unit 2 may be configured to provide 12V DC power to the power lines 47 and 48. Thus, although the connector 54 and port 55 may be configured in the same manner as existing USB ports, the drive recorder unit 2 may be configured to provide 12V power instead of conventional (i.e. lower) USB voltages. A voltage regulator 56 provides lower voltage (e.g. 3.3 volts) to lines 47A and 48A to supply power to the first processor 51 and/or second processor 52. As discussed in more detail below in connection with FIGS. 9-12, one or more additional voltage regulators 80, 82, 84, and 86 may be utilized to provide power to the various components of the adapter 25. The voltage regulator 56 permits 12V power from power lines 47 and 48 to pass through to power lines 47B and 48B whereby 12V power from recorder unit 2 is supplied through cable 27 to the analog camera 20. In general, one of the DC power lines may comprise vehicle ground, such that lines 26 and 27 do not necessarily need to include two conductive lines to provide power from recorder unit 2 to camera 20. Thus, as used herein, the terms “power line” and “conductor” may include the structure of vehicle 10. Data lines 49 and 50 may be utilized to communicate between recorder unit 2 and first processor 51 utilizing a standard USB signal format.

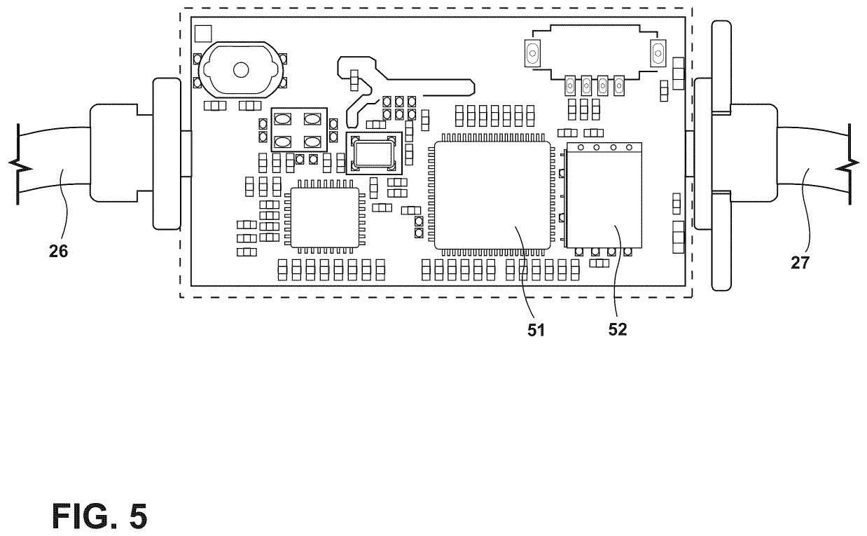

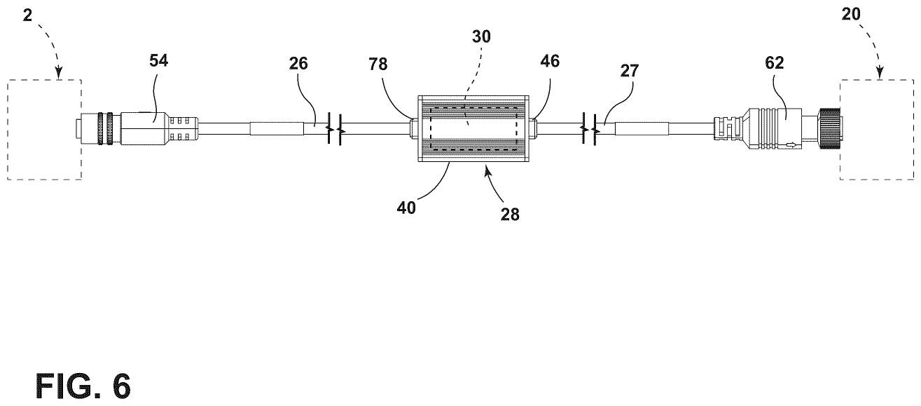

Referring again to FIG. 3, cable 27 may include a connector 62 that is configured to electrically and mechanically connect/couple the cable 27 to an analog port 63 of analog camera 20. Cable 27 may include four conductors such as first and second power lines 57 and 58, and first and second data lines 59 and 60 (see also FIGS. 4, 5). The power lines 57 and 58 are operably connected to the first and second power lines 47 and 48 to provide the analog camera 20 with a 12V power supply. As discussed above, a conductive structure of vehicle 10 may be utilized to provide a DC ground connection whereby cable 27 could comprise a single conductor 57 or 58. The first and second data lines 59 and 60 may be configured to transmit analog audio and/or video signals in a known manner/format. For example, line 59 may transmit analog audio signals, and line 60 may transmit analog video signals. The power lines 57, 58 and data lines 59, 60 may be operably connected to the PCB 41 at a connector 46.

As discussed in more detail below, the analog line 59 may be operably connected to the first processor 51, and the first processor 51 may be configured to convert analog audio signals into a digital audio signal. Data line 60 may be operably connected to the second processor 52, and the second processor 52 may be configured to convert analog video signals to digital video signals. The first and second processors 51 and 52 may be operably interconnected by one or more lines 65. The lines 65 may comprise, for example, power lines, digital signal lines, etc. The first processor 51 may be configured to receive digital video signals from second processor 52, and the first processor 51 may also convert the analog audio signals to digital audio signals. The first processor 51 may be configured to transmit the digital audio and video signals to the recorder 2 in a known format (USB) utilizing the data lines 49 and 50 of cable 27.

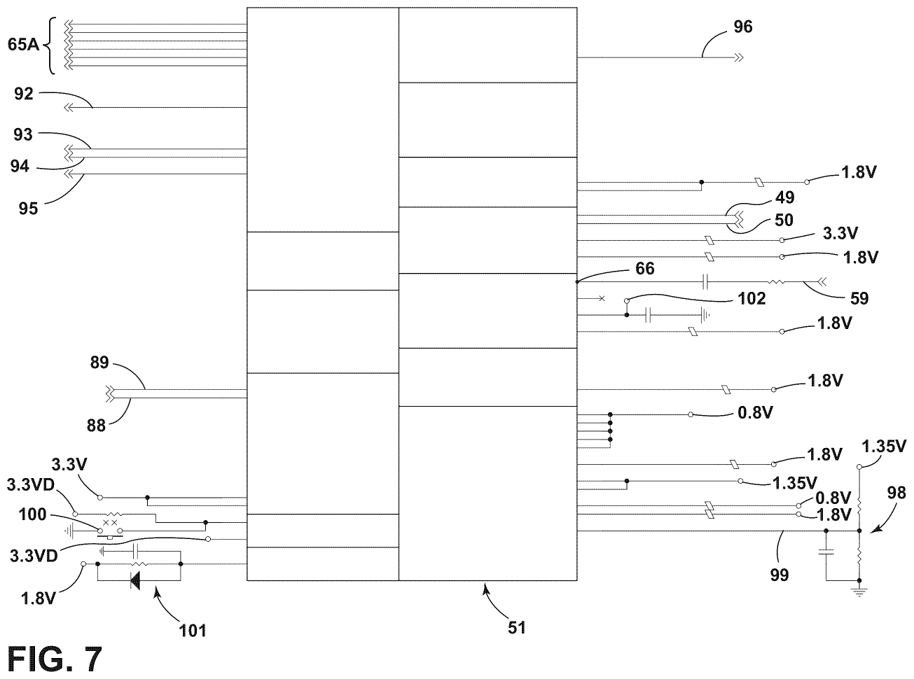

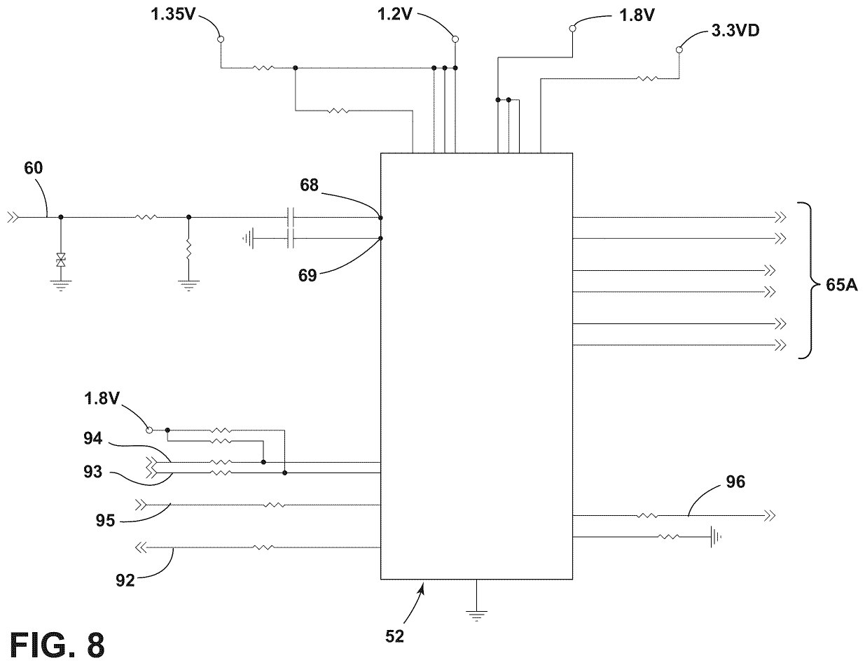

With further reference to FIGS. 7 and 8, conductive lines 65 interconnecting processors 51 and 52 may comprise traces of PCB 41. Lines 65 may comprise a plurality of data lines 65A that operably interconnect the first and second processors 51 and 52 to provide transfer of data between first and second processors 51 and 52. With reference to FIG. 7, line 59 from analog camera 20 may be operably connected to the first processor 51 at a connection point 66. The first processor 51 may be configured to convert an analog audio signal from line 59 into a digital format. As discussed above, processor 51 may also be configured to transmit digital audio data to the recorder unit 2 utilizing the first and second data lines 49 and 50.

With further reference to FIG. 8, the line 60 from analog camera 20 may be operably connected to the second processor 52 at a connection point 68. A connection point 69 may be utilized to provide a ground input to second processor 52 whereby connection points 68 and 69 provide analog video inputs to processor 52. The processor 52 may be configured to convert analog video signals from line 60 into digital video signals, which are then communicated to first processor 51 utilizing one or more conductors 65A.

Referring again to FIGS. 7 and 8, processors 51 and 52 may be operably interconnected by lines 92, 93, and 94 to synchronize the processors 51 and 52. Processors 51 and 52 may also be operably interconnected by an interrupt request 96. A divider 98 may be utilized to provide reference voltage 99 to processor 51 that is one half 1.35VD. Processor 51 may also be operably interconnected to a reboot switch 100 and reset 101. A volume control 102 may also be utilized to control the volume of the audio.

The A/D converter electronics 30 may also include a plurality of power regulators 80, 82, 84, and 86 as shown in FIGS. 9-12, respectively. Power regulator 80 (FIG. 9) may comprise, for example, a high-frequency, synchronous, rectified, step-down switch-mode converter 79 (Processor) that provides 3.3 volt power 3.3V utilizing 5 volt 5V and 12 volt 12V conductors. The 3.3V conductor of power regulator 80 may be operably connected to power regulators 82, 84, and 86 via conductors (traces) of PCB 41.

Power regulator 82 (FIG. 10) may comprise a processor 83 that is operably connected to processor 51 by lines 88 and 89 (see also FIG. 7) to control processor 83. The power regulator 82 is configured to provide 0.8V voltage and 1.35V voltage to the other components that may be mounted to PCB 41.

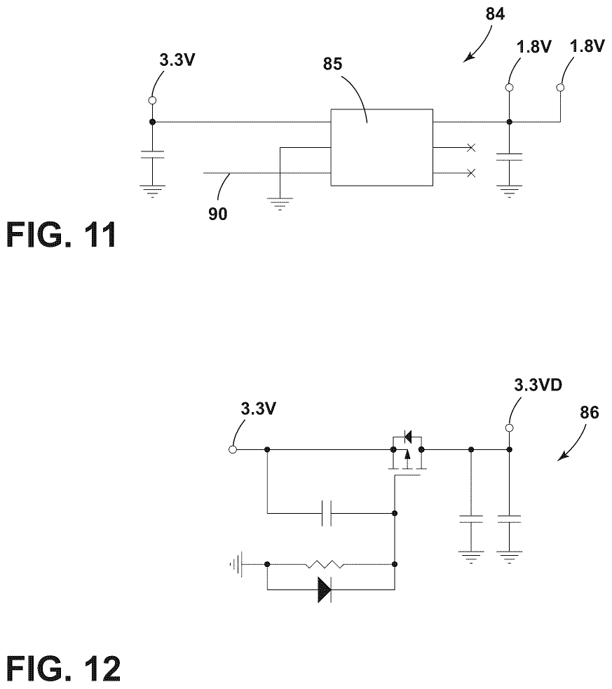

The power regulator 84 of FIG. 11 may include a regulator 85 that is configured to convert a 3.3V input to a 1.8V that may be supplied to processor 51 (FIG. 7) and/or processor 52 (FIG. 8). A line 90 may be utilized to control regulator 85.

With reference to FIG. 12, power regulator 86 may be configured to regulate a system voltage 3.3V to provide a 3.3VD output to processor 52 (FIG. 8).

The adapter 25 may also include additional features such as digital memory, a timing crystal/circuit, decoupling capacitors and other features as required.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A camera system for vehicles comprising:
a digital recording unit including a support structure and first and second cameras mounted to the support structure, wherein the support structure of the digital recording unit is configured to be mounted in a vehicle interior adjacent to a windshield of a vehicle whereby the first camera faces forward towards the windshield, and the second camera faces rearwardly away from the windshield, whereby the first and second cameras are configured to form videos that are stored in digital format by the digital recording unit, the digital recording unit including a digital connection port that is configured to send and receive digital signals and supply 12 volt DC power;
a third camera that is configured to output an analog signal from a camera port of the third camera, wherein the camera port of the third camera is configured to receive 12 volt DC power to power the third camera;
an analog camera adapter having: 1) a housing, 2) a first cable having a first end connected to the housing, and a second end having a digital connector that is configured to be operably connected to the digital connection port of the digital recording unit, and 3) a second cable having a first end connected to the housing and a second end having an analog connector that is configured to be operably connected to the camera port of the third camera, the analog camera adapter comprising:
first and second processors disposed in the housing wherein the first and second processors are operably interconnected, and wherein the second processor is configured to convert analog video signals from the third camera into digital video signals and transmit the digital video signals to the first processor, and wherein the first processor is configured to convert analog audio signals from the third camera into digital audio signals and to transmit the digital audio and digital video signals to the digital recording unit through the first cable; and wherein:
the analog camera adapter is configured to: 1) supply 12 volt DC power from the digital connection port of the digital recording unit to the camera port of the third camera utilizing first and second conductive power lines of the first and second cables, and 2) communicate with the digital recording unit utilizing first and second conductive communication lines of the first cable.

2. The camera system of claim 1, wherein:
the digital connection port of the digital recording unit comprises a female circular aviation connector plug with four openings, and the digital connector of the first cable comprises a male circular aviation connector having four pins that are configured to engage the four openings of the female circular aviation connector plug.

3. The camera system of claim 2, wherein:
the camera port of the third camera and the analog connector of the second cable comprise aviation connectors that are configured to releasably interconnect four conductive lines of the second cable to the camera port.

4. The camera system of claim 1, wherein:
the analog camera adapter includes a voltage regulator that provides 3.3 volt DC power to the first and second processors utilizing 12 volt DC power supplied by the first and second conductive power lines of the first cable.

5. The camera system of claim 1, wherein:
the analog camera adapter is configured to provide 2-way digital communication with the digital recording unit utilizing only the first and second conductive communication lines of the first cable.

6. The camera system of claim 5, wherein:
the analog camera adapter is configured to provide 2-way digital communication with the digital recording unit utilizing a USB communication protocol.

7. The camera system of claim 1, wherein:
the analog camera adapter includes a printed circuit board (PCB) disposed inside the housing;
the first and second processors are mounted to the PCB.

8. The camera system of claim 1, wherein:
the support structure of the digital recording unit includes a first portion that is configured to be fixedly secured to an interior surface of a windshield, and a second portion that is movably connected to the first portion,
the first and second cameras are mounted to the second portion of the support structure such that the second portion of the support structure can be moved relative to the first portion of the support structure to adjust the directions of the first and second cameras.

9. The camera system of claim 1, including:
an extension cable having a first end connected to the analog connector of the second cable, and a second end connected to the camera port of the third camera.

10. The camera system of claim 1, wherein:
analog to digital processing of audio signals from the third camera is performed solely by the first processor;
analog to digital processing of video signals from the third camera is performed solely by the second processor;
digital video signals from the second processor are supplied to the first processor, and the first processor communicates the digital audio and video signals to the digital recording unit utilizing the first and second conductive communication lines of the first cable.

11. A motor vehicle including the camera system of claim 1, wherein:
the housing of the analog camera adapter and portions of the first and second cables are disposed between a headliner and an outer roof layer of the motor vehicle.

12. An analog to digital camera adapter for connecting an analog camera to a digital recorder, the analog to digital camera adapter comprising:
a housing;
analog to digital convertor electronics disposed in the housing;
a first line including a digital connector that is adapted to operably couple the first line to a digital recording unit that is remote from the high definition analog camera, and wherein the first line is adapted to be operably connected to a digital output of the digital convertor electronics to provide two-way digital communication between the analog to digital convertor electronics and a digital recorder;
a second line including a connector that is adapted to operably couple the flexible analog line to a high definition analog camera, and wherein the second line is operably connected to an analog input of the digital convertor electronics;
conductive power lines that are configured to supply the connector of the second line with 12 volt DC power that is received from a digital recorder by the digital connector.

13. The analog to digital camera adapter of claim 12, wherein:
the first line consists of four conductors, wherein a first pair of the conductors are configured to provide power, and a second pair of the conductors are configured to provide two-way digital communications.

14. The analog to digital camera adapter of claim 12, wherein:
the analog to digital convertor electronics comprises at least one processor that is configured to convert analog audio signals into digital audio signals and/or to convert analog video signals into digital video signals.

15. The analog to digital camera adapter of claim 14, wherein:
the analog to digital convertor electronics comprises a first processor that is configured to convert analog audio signals into digital audio signals, and a second processor that is configured to convert analog video signals into digital video signals.

16. The analog to digital camera adapter of claim 15, wherein:
the first processor is operably connected to the second processor;
the first processor is configured to receive digital video signals from the second processor and provide digital audio and video signals to the first line in USB format;
the first processor is configured to receive digital signals from the first line in USB format.

17. The analog to digital camera adapter of claim 12, wherein:
the digital connector of the first line comprises a four-pin circular aviation connector plug.

18. A method of providing a digital recording unit with digital signals from an analog camera, the method comprising:
mounting a digital recording unit in an interior of a motor vehicle;
mounting an analog camera to the motor vehicle in a location that is remote from the digital recording unit;
interconnecting the analog camera to the digital recording unit utilizing an analog camera adapter having analog to digital electronics, wherein the analog to digital electronics are operably connected to first and second cables;
wherein interconnecting the analog camera to the digital recording unit includes interconnecting the first cable to a digital connection port of the digital recording unit, and interconnecting the second cable to the analog camera whereby analog signals from the analog camera are converted to digital signals by the analog to digital electronics and transmitted to the digital recording unit by the first cable; and:
providing 12 volt DC power from the digital recording unit to the analog camera utilizing the first and second cables.

19. The method of claim 18, including:
mounting the digital recording unit to an interior surface of a windshield of the motor vehicle;
routing the first and second cables in a space between a headliner of the vehicle and an outer roof structure;
positioning the analog to digital electronics between the headliner and roof structure of the vehicle.

20. The method of claim 18, including:
connecting an extension line to at least a selected one of the first and second cables;
mounting the analog camera to a trailer of the motor vehicle.
